(19) United States
(12) Patent Application Publication
(10) Pub. No.: US 2009/0248484 A1
(43) Pub. Date: Oct. 1, 2009

(54) AUTOMATIC CUSTOMIZATION AND RENDERING OF ADS BASED ON DETECTED FEATURES IN A WEB PAGE

(75) Inventors: Arungunram C. Surendran, Sammamish, WA (US); Ewa Dominowska, Kirkland, WA (US); Yi Zhang, Redmond, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/057,871

(22) Filed: Mar. 28, 2008

(51) Int. Cl. G06Q 30/00; G06F 17/00

(52) U.S. Cl. 705/10; 705/14

(57) ABSTRACT

Media and system are provided for customizing ads for delivery based on features in a web page. Text in a web page is evaluated to determine the sentiment of the web page. The sentiment can be based on the overall web page or on individual blocks of text within the web page. Based on the sentiment, an ad is created from the text in the web page. The resulting ad is rendered in the web page and shown to a user.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Advertisers have no way of customizing ads once they are created for delivery to a web page. In many instances, advertisers submit ads for their products to an ad service such as Microsoft adCenter by Microsoft Corporation of Redmond, Wash. These ads are created in advance and cannot be changed.

The problem with a pre-defined ad is that it may be shown on a web page that is hostile or negative to the advertiser. For example, an advertiser for a travel company may pay monies to have its ad shown on a travel website. However, other advertisers may pay monies as well vying for the same advertising space. The ad service takes into account several factors for delivering the advertiser's ad to the travel website for rendering. In addition to the monies paid, the ad service may consider the probability of the ad being selected for viewing, the relevance of the keywords submitted by the advertiser to the travel website, and the monetary value of the keyword. Once the ad service makes a selection of which advertiser's ad to display at the travel website, the ad is selected and appropriately shown. Unfortunately, no information is taken from the website to determine if the ad is really a proper fit for the website. For example, the travel website could contain travel reviews that disparage the travel company. It would be most unfortunate to render an ad from the travel company on the travel website that contains disparaging comments about the travel company. It would be beneficial to know some information about the travel website and allow an ad to be customized according to features of the website.

### SUMMARY

The present invention is defined by the claims below. Embodiments of the present invention solve at least the above problems by providing media and system for tailoring advertisements to a web page at a time of delivery, for determining how an ad is to appear in a web page, and for determining an ad for display in a web page.

Advertisements can be created and customized at a time of delivery to a web page. A person's sentiment towards an aspect or a feature of product can automatically be detected from written information in the web page. This information can come from blogs or review websites. The sentiment can be detected as being positive, negative, or neutral, and can be detected as a whole on the entire web page or detected as blocks of information within the web page. From the sentiment, an ad can be created from the written information in the web page. The ad is then rendered within the web page to be shown to a user that has accessed the web page over a communication connection.

### BRIEF DESCRIPTION OF THE SEVERAL VIEWS OF THE DRAWINGS

Illustrative embodiments of the present invention are described in detail below with reference to the attached drawing figures, which are incorporated by reference herein and wherein:

FIG. 1 is a screen shot of an exemplary web page when not implementing an embodiment of the present invention;

FIG. 2 is a screen shot of an exemplary web page when implementing an embodiment of the present invention;

FIG. 3 is a flowchart of an exemplary process for tailoring advertisements to a web page at a time of delivery when practicing an embodiment of the present invention;

FIG. 4 is a flowchart of an exemplary process for determining how an ad is to appear in a web page when practicing an embodiment of the present invention; and

FIG. 5 is a flowchart of another exemplary process for determining an ad for display in a web page when practicing an embodiment of the present invention.

### DETAILED DESCRIPTION

Embodiments of the present invention provide media and system for tailoring advertisements to a web page at a time of delivery, for determining how an ad is to appear in a web page, and for determining an ad for display in a web page.

Many different arrangements of the various components depicted, as well as components not shown, are possible without departing from the spirit and scope of the present invention. Embodiments of the present invention will be described with the intent to be illustrative rather than restrictive. Alternative embodiments will become apparent to those skilled in the art. A skilled artisan may develop alternative means of implementing improvements without departing from the scope of the present invention.

### Acronyms and Shorthand Notations

Throughout the description of the present invention, several acronyms and shorthand notations are used to aid the understanding of certain concepts pertaining to the associated system and services. These acronyms and shorthand notations are solely intended for the purpose of providing an easy methodology of communicating the ideas expressed herein and are in no way meant to limit the scope of the present invention. The following is a list of these acronyms:

| | |
|---|---|
| CD | Compact Disc |
| CD-ROM | Compact Disc-Read-Only Memory |
| DVD | Digital Versatile Discs |
| EEPROM | Electrically Erasable Programmable Read-only |
| | Memory |
| PC | Personal Computer |
| PDA | Personal Digital Assistant |
| RAM | Random Access Memory |
| ROM | Read-Only Memory |

Further, various technical terms are used throughout this description. A definition of such terms can be found in Newton's Telecom Dictionary by H. Newton, 23 Edition (2007). These definitions are intended to provide a clearer understanding of the ideas disclosed herein but are not intended to limit the scope of the present invention. The definitions and terms should be interpreted broadly and liberally to the extent allowed the meaning of the words offered in the above-cited reference.

As one skilled in the art will appreciate, embodiments of the present invention may be embodied as, among other things: a method, system, or computer-program product. Accordingly, the embodiments may take the form of a hardware embodiment, a software embodiment, or an embodiment combining software and hardware. In one embodiment, the present invention takes the form of a computer-program product that includes computer-useable instructions embodied on one or more computer-readable media.

Computer-readable media include both volatile and nonvolatile media, removable and nonremovable media, and contemplates media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. An exemplary modulated data signal includes a carrier wave or other transport mechanism. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

### Ad Customization

In an implementation of an embodiment of the present invention, an advertisement can be customized at a time of delivery to a web page rather than be pre-defined in advance. The customization can take various features of the web page into consideration in order to create an advertisement as indicated in the following manner.

In a first aspect, advertisements are tailored to a web page at a time of delivery. Words are evaluated in the web page to determine separately a product for advertising. Sentiments are determined about the product from an evaluation of the words. An extracted summary or a descriptive summary is created based on the sentiments. Either the extracted summary or the descriptive summary is placed into a template to form an advertisement focused on the product. The advertisement is rendered in the web page.

In another aspect, a determination is made how an ad is to appear in a web page. In the web page, text is evaluated that discusses a product. The text is grouped into blocks where the blocks discuss the product. Each of the blocks is classified as having a positive sentiment, a negative sentiment, or a neutral sentiment for the product or an aspect of the product. A determination is made whether the ad is to be placed in the web page based on sentiments assigned to the blocks. If the ad is to be placed in the web page, the ad is created with words from the text of the web page. The ad is rendered in the web page.

In yet another aspect, a system having a computer with a processor and a memory, to determine an ad for display in a web page is provided that includes determining a set of advertisers that desire to place ads in the web page. The advertisers provide a name of a product, a link to a product web page of the product, and keywords associated with the product. A first subset of the set of advertisers is determined based on at least an amount paid by an advertiser to display the ad, a probability of the ad being selected by a user, or a relevance of the keywords to the web page. A second subset of the set of advertisers is determined from the first subset based on an evaluation of the web page. Sentiments about products or an aspect of the products are determined from the evaluation. The advertiser is selected where the sentiments are positive about the product or the aspect of the product of the advertiser. The ad for the advertiser is created with words in the web page. The ad is rendered in the web page.

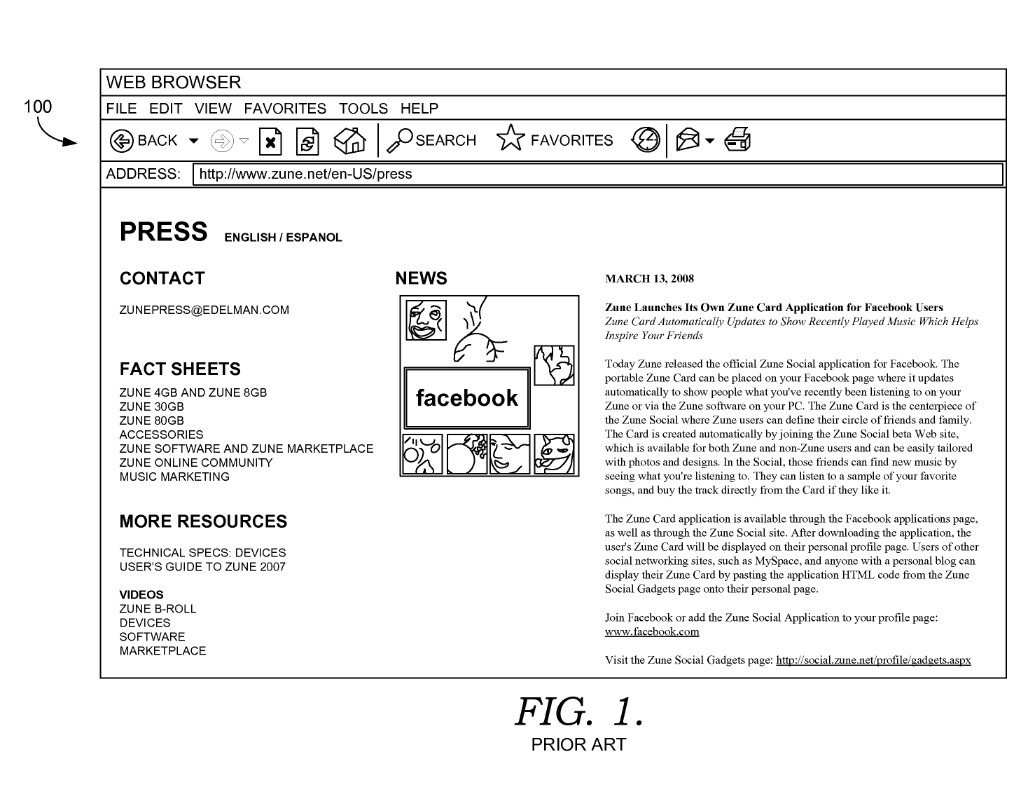

In FIG. 1 an exemplary web page 100 is shown. Web page 100 is an illustration when not implementing an embodiment of the present invention. Web page 100 can be any web page that is accessed at a display by a user with a connection to the Internet. The information indicated in web page 100 is exemplary and can be different types of information that show among other things, other products, services, or types of information where a user accesses the Internet. In web page 100, information is provided for products and services for Zune which is manufactured by Microsoft Corporation of Redmond, Wash. In particular, the text that is shown in web page 100 focuses on applications involving the Zune product. As one can see in web page 100, several paragraphs are provided regarding the Zune product and the Zune social application program.

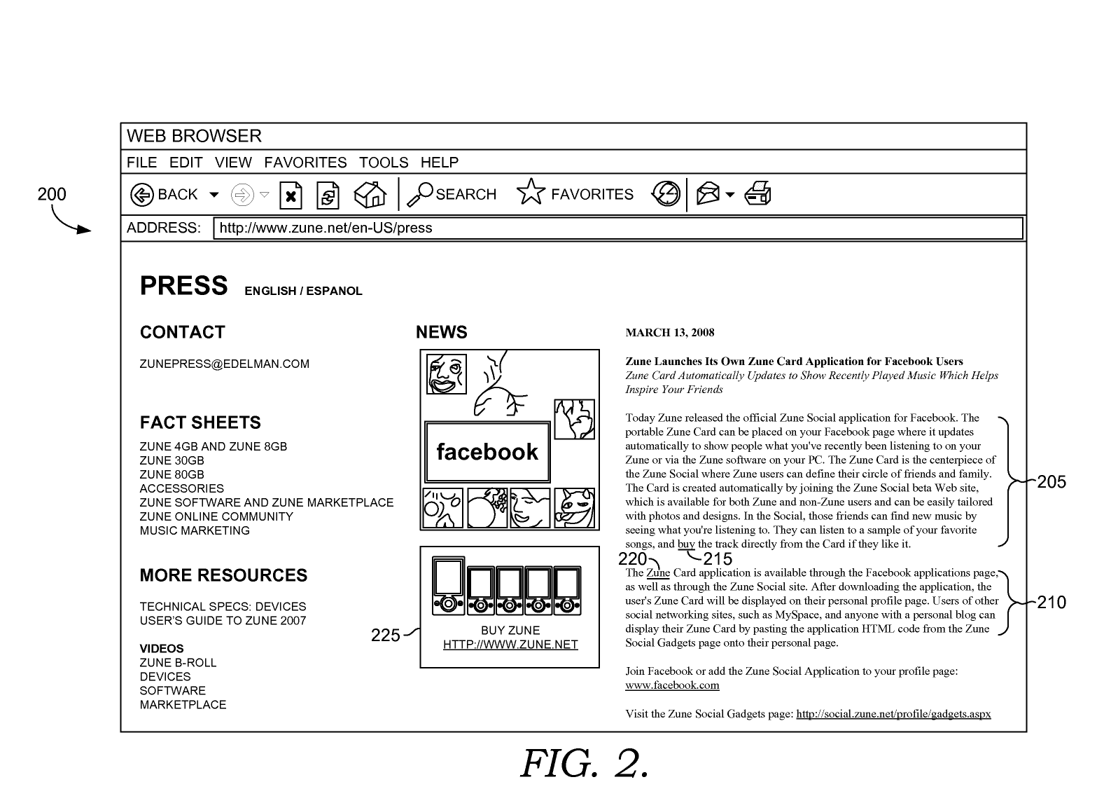

Turning now to FIG. 2, an exemplary web page 200 is shown illustrating an implementation of an embodiment of the present invention. In web page 200, a block of text 205 is shown which discusses the Zune product and other information. Also, another block of text 210 is shown in a separate paragraph from the text 205. When implementing an embodiment of the present invention, text 205 and text 210 are analyzed in the present invention to determine the sentiment of the text. For example, when analyzing text 205, an embodiment analyzes the various words to determine whether the sentiment is positive, negative, or neutral. This analysis can be performed with various algorithms including a natural language processing algorithm. The embodiment can determine an overall sentiment for the entire web page or can be determined for each text 205 and text 210. For illustrative purposes here, text 205 and text 210 are viewed as having both positive sentiments.

Once a determination is made about the sentiment, an embodiment of the present invention searches for words or phrases to create an extracted summary or a descriptive summary. These summaries are used to create the ad that will be rendered in web page 200. In FIG. 2, a word 215 is selected in text 205 and a word 220 is selected in text 210. Word 215 indicates the word “buy” and word 220 indicates the word “Zune.” Both words are used in the impending ad that will be created.

Words or phrases are taken and placed in the ad as illustrated by ad 225. Ad 225 is created upon the delivery of the web page to the user at their computing device. Ad 225 is created once the web page is accessed rather than being created in advance. In FIG. 2, ad 225 is created from several information. It contains a photograph of the Zune player. Underneath the photograph, it includes the words “buy Zune” which are taken from words 215 and 220. It contains a URL that can be selected by the user. In one embodiment, ad 225 can be created in real time and placed directly in web page 200. In another embodiment, ad 225 may be created wherein the information from words 215 and 220 are placed within a predetermined template provided by an advertiser where the resulting ad template is filled in and then rendered in web page 200.

Although words 215 and 220 are selected to create ad 225, words 215 and 220 are indicative of the extracted summary where selected words and phrases are obtained and placed directly into the ad. In another aspect of the invention, a descriptive summary can also be created. The descriptive summary is a variety of words and phrases that are selected and reformed to provide advertising information that can be placed in ad 225. For example, several words or phrases from text 225 or text 210 can be selected and then reformulated to illustrate a slogan to purchase the product, to promote the product, or to indicate where to purchase the product. The information can then be provided to a template to create the ad such as ad 225.

In another embodiment, the location of ad 225 can vary according to the desires of the implementer. In FIG. 2, ad 225 is placed directly under another photograph that was previously rendered in web page 100. Although the location of ad 225 was directly under the photograph that is already illustrated in web page 100, ad 225 can also be located in another position.

For those web pages where the sentiment varies according to different blocks of information such as a positive sentiment for the first paragraph, a negative sentiment for the second paragraph, another positive sentiment for another paragraph, and may be a neutral sentiment, the ad can be located in proximity or near the text of information where the sentiment is positive. Or, a decision can be made in an implementation of the embodiment not to show an ad at all. For example, if the overall sentiment is negative then a decision may be made not to show an ad from a particular manufacturer or advertiser. Furthermore, if the overall sentiment is negative or neutral, a decision may be made to show a competitive product in place of the original intended product.

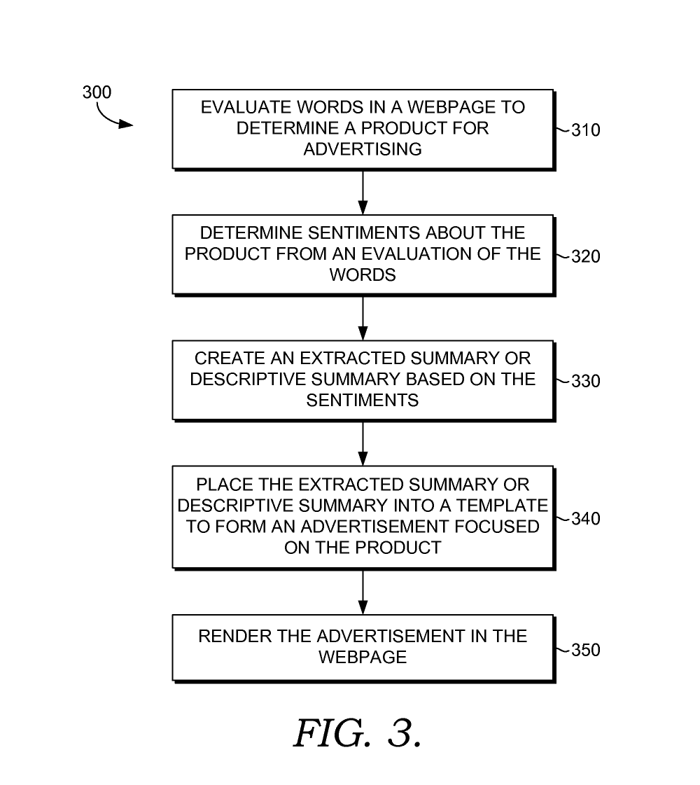

In FIG. 3, a process for tailoring advertisement to a web page at a time of delivery is shown in a method 300. In a step 310, words are evaluated in a web page to determine a product for advertising. As shown in FIG. 2, words 215 and 220 are selected from text 205 and text 210. The words in text 205 and text 210 are evaluated to come up with words 215 and 220. Word 215 indicated “buy” and word 220 indicated “Zune.” In a step 320, sentiments are determined about the product from an evaluation of the words in text 205 and text 210. As discussed above, sentiment can be based on each block of text or the sentiment can be based on the overall web page. In a step 330, either an extracted summary or a descriptive summary is created based on the sentiment. The extracted summary or the descriptive summary provides a basis for providing text for the ad that is to be created. In a step 340, either the extracted summary or the descriptive summary is placed into a template to form an advertisement focused on the product. Once the ad is created, the ad is rendered in the web page 200 as ad 225 which is a step 350.

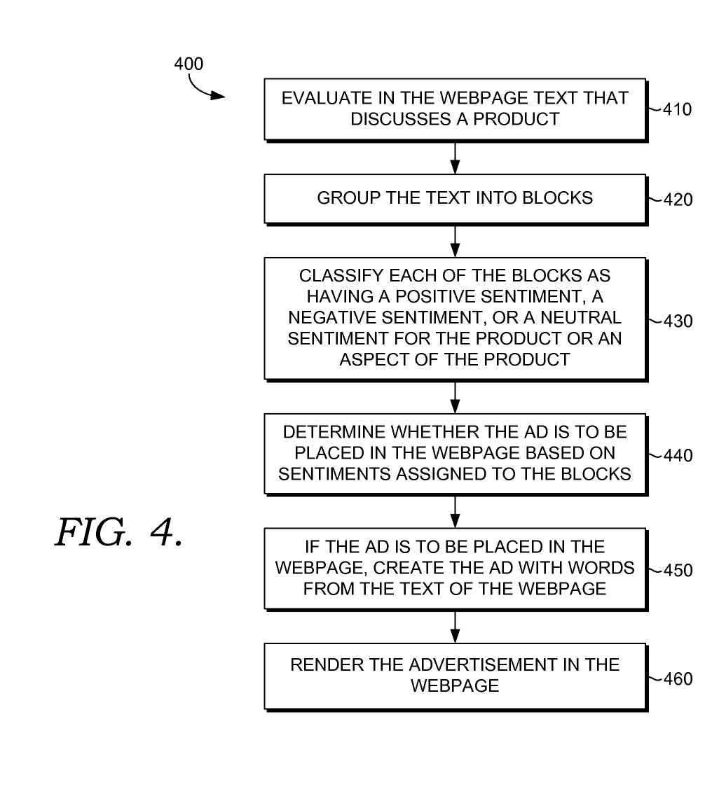

In FIG. 4, a process for determining how an ad is to appear in a web page is shown in a method 400. In a step 410, text is evaluated that discussed a product. This evaluation occurs in the web page in a step 420. The text is grouped into blocks as shown by text 205 and text 210 from FIG. 2. In a step 430, each block of text is classified as having a positive sentiment, a negative sentiment, or a neutral sentiment for the product or an aspect of the product. In an embodiment of the present invention, sentiment can be based on the product in general or on an aspect of the product. For example, information may discuss a particular feature of a camera such as the types of lens, the quality of the lens, or the strength of the lens. Or, information may be written that discusses the warranty provisions for a manufacturer, the quality of that warranty, or the ease in obtaining warranty services. These items are considered objects or aspects of the product and not the actual product itself. In relation to the Zune product, several objects or aspects may be discussed in a blog or a review of the product. For example, information can be provided on the ease in downloading music. In addition, a discussion can be provided regarding the various colors and features and capacity of the various Zune devices. In yet another aspect, information can be written than discusses the ability of the Zune product to interface with other applications. All of the information that is discussed above indicates a variety of objects or aspects that can be provided. With each object or aspect, a sentiment can be generated.

In a step 440, a determination is made whether an ad is to be placed in the web page based on the sentiments that have been assigned to the blocks of text. In a step 450, if the ad is to be placed in the web page, the ad is created with words from the text of the web page as was discussed in FIG. 2. In a step 460, the advertisement is rendered on a web page as shown by ad 225 in FIG. 2.

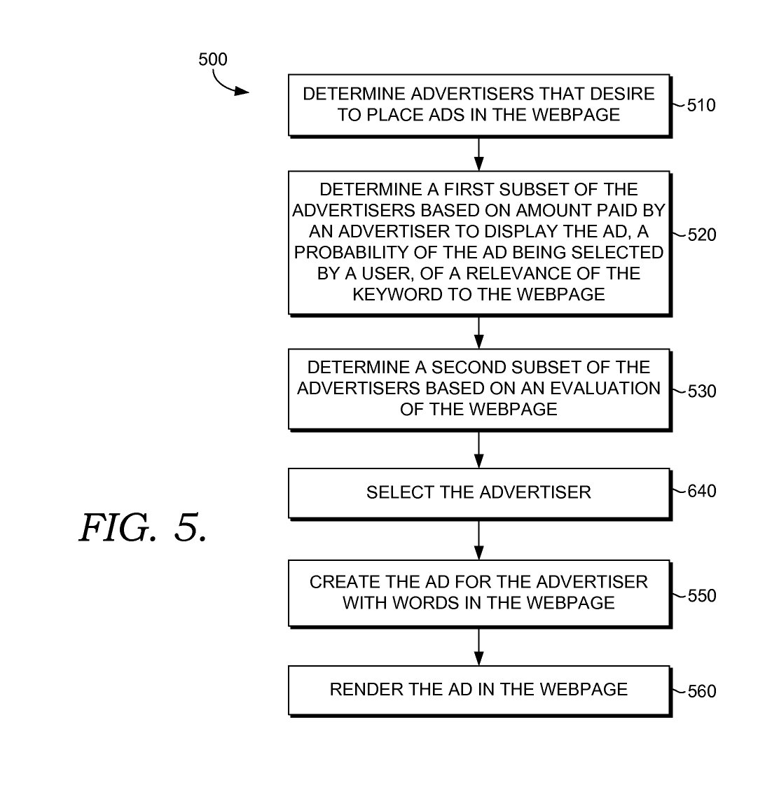

Turning now to FIG. 5, a process for determining an ad for display in a web page is shown in a method 500. In a step 510, advertisers start the process with a determination for their desire to place ads in the web page. This desire and determination can take on many forms. One such form is having advertisers submit their ads to an ad service. The ad service manages and operates a program whereby ads are rendered into various web pages. Typically, the ad service takes ads from advertisers or manufacturers and based on certain criteria renders the ads into various web pages.

In an embodiment of the present invention, advertisers do not provide an ad to the ad service. Advertisers provide other types of information as will be shown below.

In a step 520, a first subset of the advertisers are determined based on the amount paid by an advertiser to display their ad, a probability of the ad being selected by a user, or the relevance of the key words. Step 520 is indicative of the process that is followed for the auctioning of ads. For example, to gain a better understanding, advertisers vie for having their ads placed in web pages. This activity is usually called an auction since there are limited space on a web page with limited time to display the ad. In a scenario, ten advertisers, which are representing ten manufacturers, may desire to advertise on a particular web site. Those advertisers pay a fee or indicate to the ad service the amount of monies they are willing to pay for their ad to be shown. In an aspect, the highest bidder has an opportunity to get their ad placed in the particular desired web page. But, in addition to the bidding to have an ad displayed in the web page, the ad service may also have or may determine other factors such as the probability of a particular ad being selected by a user. For example, if one of the advertisers is a travel company and the web page is a travel web site, the probability is higher that a user or the user will select the ad rendered by the travel company.

The ad service may also determine another factor in selecting an advertiser to render their ad on the web page based on how relevant a keyword is to the particular web page. Typically, advertisers provide certain keywords to the ad service. A camera company can provide several keywords about their particular camera product. So, whenever a web site has information containing the keyword, that particular advertiser for the camera company becomes a candidate for having their information about their camera product displayed as an ad in the particular web page.

Going back to the travel scenario, the travel company may submit a keyword such as “Hawaii”, “resort”, or “airfare”. Those three key words are relevant to the travel industry and may result in a higher probability that the travel company's ad may be selected for rendering in the travel web site. However, with an implementation of the present invention, the advertiser no longer provides an ad to the ad service, but as shown in a step 530, a second subset of the advertisers are determined based on an evaluation of the web page. This evaluation is based on determining sentiments as shown by text 205 and text 210 in FIG. 2. In a step 540, the advertiser is selected. In a step 550, the ad is created for the advertisers from words in the web page. As shown in FIG. 2, words 215 and 220 provide the words to help create ad 225. In a step 560, the ad is rendered in web page 200.

The prior discussion is only for illustrative purposes to convey exemplary embodiments. The steps discussed in FIGS. 3-5 may be executed without regards to order. Some steps may be omitted and some steps may be executed at a different time than shown. For example, step 530 may be executed before step 520. The point here is to convey that the figures are merely exemplary for the embodiments of the present invention and that other embodiments may be implemented for the present invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. One or more computer-readable storage media having computer instructions embodied thereon for performing a method for tailoring advertisements to a web page at a time of delivery, the method comprising:
evaluating one or more words in the web page to determine separately a product for advertising;
determining one or more sentiments about the product from an evaluation of the one or more words;
creating at least one of an extracted summary and a descriptive summary based on the one or more sentiments;
placing the at least one of the extracted summary and the descriptive summary into a template to form an advertisement focused on the product; and
rendering the advertisement in the web page.

2. The media of claim 1, wherein the extracted summary is a phrase taken from information shown in the web page.

3. The media of claim 2, wherein the descriptive summary is a set of phrases created from a variety of text shown in the web page.

4. The media of claim 1, wherein determining the one or more sentiments comprises determining whether one or more persons like or dislike the product.

5. The media of claim 4, wherein determining the one or more sentiments comprises operating a natural language processing algorithm to determine a sentiment from the one or more words.

6. The media of claim 4, further comprising rendering the advertisement in the web page near a set of text with a sentiment where a person likes the product.

7. The media of claim 4, further comprising associating the one or more sentiments to one or more objects of the product wherein the one or more objects are aspects of the product or features of the product.

8. One or more computer-readable storage media having computer instructions embodied thereon for performing a method for determining how an ad is to appear in a web page, the method comprising:
evaluating, in the web page, text that discusses a product;
grouping the text into one or more blocks wherein the one or more blocks discuss the product;
classifying each of the one or more blocks as having a positive sentiment, a negative sentiment, or a neutral sentiment for the product or an aspect of the product;
determining whether the ad is to be placed in the web page based on one or more sentiments assigned to the one or more blocks;
if the ad is to be placed in the web page, creating the ad with one or more words from the text of the web page; and
rendering the ad in the web page.

9. The media of claim 8, further comprising deciding to place the ad in the web page when the one or more blocks have a majority of the positive sentiment.

10. The media of claim 9, further comprising deciding not to place the ad in the web page when the one or more blocks have a majority of the negative sentiment.

11. The media of claim 10, further comprising deciding to place a competitor ad rather than the ad in the web page.

12. The media of claim 8, wherein creating the ad with the one or more words comprises filling in an ad template with the one or more words.

13. The media of claim 12, wherein the ad template is provided by advertisers.

14. The media of claim 8, further comprising selecting one ad template from one or more ad templates provided by an advertiser.

15. The media of claim 14, further comprising customizing the ad template for the ad to be displayed in the web page.

16. The media of claim 8, further comprising locating the ad near a member of the one or more blocks that have the positive sentiment.

17. A system having a computer with a processor and a memory, to determine an ad for display in a web page, comprising:
determining a set of advertisers that desire to place ads in the web page wherein the advertisers provide a name of a product, a link to a product web page of the product, and one or more keywords associated with the product;
determining a first subset of the set of advertisers based on at least one of an amount paid by an advertiser to display the ad, a probability of the ad being selected by a user, and a relevance of the one or more keywords to the web page;
determining a second subset of the set of advertisers from the first subset based on an evaluation of the web page wherein one or more sentiments about one or more products or an aspect of the one or more products are determined from the evaluation;
selecting the advertiser wherein the one or more sentiments are positive about the product or the aspect of the product of the advertiser;
creating the ad for the advertiser with one or more words in the web page;
and rendering the ad in the web page.

18. The system of claim 17, wherein creating the ad comprises filling in an ad template with information about the product.

19. The system of claim 17, further comprising locating the ad near a set of text in the web page wherein the set of text includes a sentiment that is positive.

20. The system of claim 17, wherein the evaluation of the web page comprises an analysis of the one or more words in the web page.
